(19) United States
(12) Patent Application Publication
(10) Pub. No.: US 2017/0195373 A1
(43) Pub. Date: Jul. 6, 2017

(54) SYSTEM FOR AUTOMATIC, CUSTOM FOREIGN CONTENT INSERTION INTO DIGITAL CONTENT STREAMS

(71) Applicant: CINCHCAST, INC., New York, NY (US)

(72) Inventors: Andy Toh, Brooklyn, NY (US); Enrique Allegretta, Buenos Aires (AR); Pablo Muro, Buenos Aires (AR); Benjamin Eidelman, Buenos Aires (AR); Brian McConnell, Brooklyn, NY (US); Avrohom Y. Charish, New York, NY (US)

(21) Appl. No.: 15/459,986

(22) Filed: Mar. 15, 2017

Related U.S. Application Data
(63) Continuation-in-part of application No. 14/577,580, filed on Dec. 19, 2014.
(60) Provisional application No. 62/085,889, filed on Dec. 1, 2014.

(51) Int. Cl. H04L 29/06; G06Q 30/02; H04L 29/08

(52) U.S. Cl. CPC H04L 65/1089; H04L 67/06; G06Q 30/0254; G06Q 30/0255; H04L 65/403; H04L 67/42

(57) ABSTRACT

Embodiments of the systems and methods disclosed herein enable automated and customized insertion of advertisements in real-time and in response to a request for a content file. Purveyors of content, such as audio and video, often use advertisements to ensure profitability. Embodiments enable users to customize the location(s) for advertisement insertion, and further embodiments allow for real-time insertion of ads, the ads can further be customized to the ad recipient. Real-time, automated delivery improves current technology in several ways by, for example, eliminating the need to manually inserting or choosing advertisements, customizing advertisement delivery to the content recipient, improving the speed of delivery of ad-supported content, giving users the ability to customize the location of advertisement insertion, thereby improving the final ad-supported product by inserting ads in logical, non-pre-planned locations of content files.

### CROSS-REFERENCE TO RELATED APPLICATIONS

This application is a continuation-in-part and claims priority to U.S. patent application Ser. No. 14/577,580, filed on Dec. 19, 2014, which is hereby incorporated by reference in its entirety. This application also claims priority to provisional appl. no. 62/085,889, filed on Dec. 1, 2014, which is hereby incorporated by reference in its entirety.

### BACKGROUND

A. Technical Field

Embodiments generally relate to inserting foreign content within digital audio content distributed via the web.

B. Background

There are established ways of inserting advertising content into the beginning and end of an audio file, known as pre- and post-roll advertising, being delivered to listeners who are either listening to the audio content via a streaming service or via a download. In the musical context, multiple songs, each singular audio files in their native form, could be delivered to a listener as part of a continuous stream, one song after the other. In this context, advertising content can be inserted into the steam, either at the beginning or the end of the song. This model has enabled online music services to come up with different ad frequency levels, to determine how much advertising content to deliver to their listeners, using the song boundaries (or individual music files) as a means to determine logical breakpoints within the stream to insert an audio advertisement, following which the next song will play to continue the listening experience. These prior art methods are similar to traditional radio broadcasts in which ads are manually inserted in between songs.

Prior art methods of delivering concatenated audio files and inserting ads in between them works fairly well for music, since music content does tend to be shorter, which enables services to determine their optimal ad loads (how many songs before an ad is delivered) based on number of songs played so as not to disrupt the listener's experience of any given song.

### SUMMARY

Prior art methods of delivering concatenated audio files and inserting ads in between does not work well with non-music audio content such as talk-radio programming and podcasts, where each unit of content is an episode, content tends to be of longer form, ranging 15 minutes to 3 hours or more in length. To feature audio advertising content within individual episodes of content, platforms delivering such programming can currently add audio advertising into such programming only in a number of ways:
At the beginning or end of the audio episode, which limits the maximum number of ads that could be inserted into an audio episode, regardless of the length of the content.
Time-based breakpoints within that audio content where the ad content would be inserted (e.g., insert an ad every x minutes in the content). This method is problematic because ads may come in at points that are not editorially logical, which disrupts the listening experience.

Embodiments enable dynamically inserting advertising content and other foreign content into an audio file at customized locations, while maintaining editorial integrity of the audio content. A web-based software system consisting of a user interface for human users to insert visual markers within and delete segments in a content file in, for example, a point-and-click manner. After identifying markers in the content file, a software process can translate the visual edit decisions and insertion markers into a software-consumable data format that is stored as an insertion marker. Later, users can request the content file, either via download or a streaming request, the system and method can read the insertion markers for that content file, reconstruct that file with ads or other foreign content inserted at points defined by the insertion markers, and deliver the reconstructed file in real-time for the user. The insertion markers can be time indications, such that the audio server system can identify locations in a content file to insert an advertisement or other foreign content. It is important to perform this operation in real-time as users expect real-time responses to download or streaming requests. Humans are incapable of performing these tasks in real-time, and the embodiments described herein improve technology for content delivery by adding the ability of real-time add insertion at custom locations to deliver unique advertising content or other foreign content.

Content used in embodiments can be recorded via a method of providing an audio/video conference in near real-time. Embodiments include audio/visual conferences over PSTN or voice over IP (VOW), or any other communication medium as is known in the art. In the system, audio is received from a moderator via a network. Then, a representation of the audio is transmitted to one or more first listener(s) via a public switched telephone network, and a representation of the audio is transmitted to one or more second listener(s) via the Internet.

Audio Content can be delivered to listeners in at least two ways—a) streaming audio delivered to a listener when they hit “play” on the audio/video players, such as those running on a local application or on the web, or b) audio files delivered to listeners via a download (they can listen to via their own system player like iTunes™ or QuickTime™ or any audio player) when they make an individual download request either off of our site or via our RSS feeds.

Talk radio format audio is long, typically 20 minutes to 3 hours in length, very different from music which tends to run from 2.5 minutes to 12 minutes in length. For a music streaming service, ad loading decisions are easy—it is a matter of deciding how many songs you want to play for the listener before an ad is inserted BETWEEN songs within a stream to the listener. For longer talk format content, one could easily insert an ad BEFORE and AFTER a talk show as it is delivered to the listener, but this may not be fully utilizing the available attention of the user to expose more ads within the file itself. Secondly, ads inserted into talk format content can be very disruptive if they are not inserted at logical pints of the conversation within the talk format audio show.

A) In the streaming use case, one could define fixed insertion points, but those insertion points will likely break programming flow. One way to do this is to place static ads into the audio file itself before distribution, but this would require manually switching out the ads by manually editing the audio file to replace ads when needed.

B) The download use case faces more problems:

i) Editorial coherence because it is difficult to determine where to place ads into a file.

ii) Manually inserting ads into the audio file means switching out the ads and manually editing the files and inserting new ads.

iii) To insert the ads dynamically and automatically (ability to switch ads in and out) for downloads and at scale, requires minimizing the wait time for the listener waiting for the download to complete.

Without capturing logical insertion points from the content producer, it is hard for the system to know the best points to place insertion markers without disrupting program flow. Embodiments of this disclosure solve the insertion of ads into audio content (delivered via a multitude of ways) in an editorially coherent way while meeting listener expectations of streaming and download experience.

Embodiments include a system and method for capturing editorially relevant ad insertion points, and desired deleted segments for an audio file that the content producer specifies via a visual user interface, which will then create a set of insertion markers that can be consumed by the audio server system for delivering content to listeners.

Content files can be obtained in a variety of ways. One example is live recordings, in which ad insertion points can be labeled in real-time during recording. In a second embodiment, ad insertion points can be labeled after recording a live recording. In this embodiment, the recording can be automatically entered into an ad-insertion tool, or can be uploaded to such a tool after recording. In a third embodiment, content files, such as audio, can be created and uploaded for ad insertion.

In the live recording embodiment, there can sometimes be a delay between when content is generated and when it is streamed to recipients. This can allow for time between when an ad insertion point is generated and retrieval of an advertisement. This time delay should be at least a few seconds to account for the worst-case time it would take to retrieve an advertisement or other foreign content to insert into the live stream, or recorded media stream for later playback.

Embodiments include players that use open ad standard tags that can read these insertion markers, make the request to external ad servers for ads, and insert the ads as the content is being streamed to the listener in real-time

The audio streaming server that receives a download request reads these insertion markers that were set by the content producer, and can execute deletion instructions to delete segments of the content, and makes requests to external ad server to request ads and inserts them at precise points based on these instructions into the downloaded audio file, as it is downloaded by the listener in real-time, ads and delete decisions can be applied to the file as the file is being delivered to the user.

Another aspect is the technology that enables a content producer to mark up the audio file using a visual user interface to capture their decisions to add or delete insertion markers from content files.

In this way, content files can be delivered for streaming or downloaded for offline playback, and the content files can have unique media, such as advertisements, inserted into the content to target the particular user or deliver ads as part of a current ad campaign. This is important because if the same advertisement is delivered to all users every time the content file is downloaded, the advertisement will not be targeted and revenue will not be optimized by increasing the number of advertisement placement opportunities. Previously, content creators would have one ad placement opportunity per advertisement slot. Now, the number of advertisement slots is limited only by the number of times the content file is distributed to recipients, as each recipient could potentially receive a unique advertisement or set of advertisements.

Embodiments comprising streaming media can be more lucrative because more information can be gleaned about the user. For example, the system can identify the user via their Internet Protocol address and cookies stored on their computer. When a file is downloaded, the system cannot be sure who will be listening to the file and might not have access to as much personally identifiable information, and advertisements may not be as targeted.

In one version, the method further comprises providing the moderator with a telephone number that corresponds to a moderator position within the audio/video conference. The telephone number can be posted on a web page or provided in an advertisement typically distributed to the public. This is an example of the type of advertisement or foreign content (e.g., sounds and other pre-recorded content) that can be inserted into audio or video content.

In each of the embodiments described above, a representation of the audio/visual conference (including audio file(s) played) can be recorded for purposes of archiving or later playing, or streamed in real-time to virtually any listener wishing to listen to or view the audio/visual conference. Playback of archived audio/video conferences can include, as described in more detail throughout this specification, synchronization of the audio and playback of ads or foreign content.

Embodiments solve several problems. In a first example, users of this system and method can customize the insertion points of advertisements or other foreign content. In a second example, ads can be inserted in real-time when a recipient requests a content file. This allows for customizing ads for the recipient, ensuring that advertisements are associated with a current ad campaign, and content delivery occurs in real-time, thereby ensuring the fast response that recipients expect. Third, allowing users to determine the location of advertisements after generating a content file diminishes the need for content creators to pre-determine the location of advertisements. For instance, current content creators write scripts with predetermined ad locations, or might insert ads in locations determined by a user or host.

### BRIEF DESCRIPTION OF THE DRAWINGS

So that the above recited features and advantages of example embodiments can be understood in detail, a more particular description of embodiments, briefly summarized above, may be had by reference to the embodiments thereof that are illustrated in the appended drawings. It is to be noted, however, that the appended drawings illustrate only exemplary embodiments and are therefore not to be considered limiting of its scope, for the invention may admit to other equally effective embodiments.

FIG. 1 illustrates a schematic representation of an audio/video conference system constructed in accordance with exemplary embodiments.

FIG. 2 illustrates a schematic representation of an audio server system constructed in accordance with exemplary embodiments.

FIG. 3 illustrates exemplary “upload files” and “moderator status” web pages generated by a web server of the audio server system in accordance with example embodiments.

FIG. 4 illustrates exemplary “Segments” web page generated by the web server of the audio server system in accordance with exemplary embodiments.

FIG. 5 illustrates an exemplary “segment/archives” web page generated by the web server of the audio server system in accordance with example embodiments.

FIG. 6 illustrates exemplary structure for customizing insertion markers in a content file.

FIG. 7 illustrates exemplary structure for downloading a content file and automatically choosing and inserting advertisements or other foreign content into the content file.

FIG. 8 illustrates a first example of inserting an advertisement.

FIG. 9 illustrates a second user interface for inserting an advertisement into a content file.

FIG. 10 illustrates a user interface for deleting a segment of a content file.

FIG. 11 a flow chart illustrating an embodiment of a method for placing and retrieving insertion markers.

FIG. 12 illustrates exemplary structure for inserting advertisement or foreign content into a live audio stream.

FIG. 13 illustrates an exemplary live studio with an insert ad button that can be used to generate insertion markers.

### DESCRIPTION

The following description of the exemplary embodiments of the invention is not intended to limit the invention to these exemplary embodiments, but rather to enable any person skilled in the art to make and use this invention. Presently, exemplary embodiments of the invention are shown in the above-identified figures and described in detail below. In describing the exemplary embodiments, like or identical reference numerals are used to identify common or similar elements. The figures are not necessarily to scale and certain features and certain views of the figures may be shown exaggerated in scale or in schematic in the interest of clarity and conciseness.

### 1. Hardware of the System

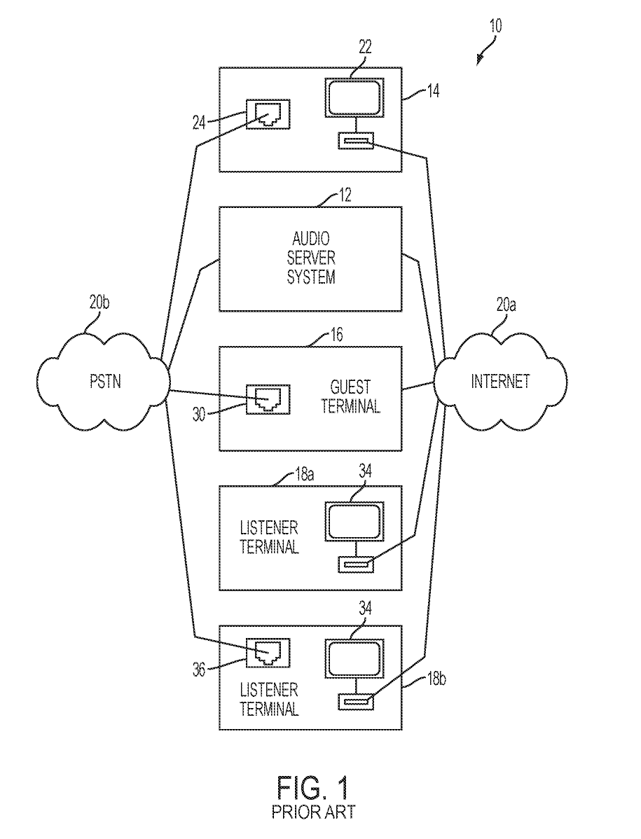

As shown in FIG. 1, example embodiments relate to a computer-based system and method that administrates network-based audio conferencing enabling users to schedule, moderate, and attend network-based conferences, without manual system administration. One example embodiment may be used to schedule and administer one or more simultaneous talk shows or audio/visual conferences. As will be described in more detail below, in an embodiment, the computer-based system is a platform that allows a person to moderate a live talk show or audio/visual conference online using only a telephone and a computer terminal having access to the Internet and a web browser.

Referring to FIG. 1, shown therein is a block diagram of an exemplary audio conferencing system 10 suitable for implementing embodiments. The audio conferencing system 10 includes one or more audio server systems 12; one or more moderator terminals 14; one or more guest terminals 16; one or more listener terminals 18a and 18b; and one or more networks 20a and 20b. Only one audio server system 12, one moderator terminal 14, one guest terminals 16, two listener terminals 18a and 18b; and two networks 20a and 20b are shown in FIG. 1 as an example.

The moderator terminal 14 includes a computer terminal 22 and a two-way audio communication device 24, such as a landline telephone, mobile telephone, VOIP, soft phone or the like, indirectly connected to the audio server system 12 via the networks 20a and 20b. Although the two-way audio communication device 24 is shown separately, the two-way audio communication device 24 can be implemented as a part of the computer terminal 22 so long as such computer terminal 22 is adapted for audio communication. For example, the computer terminal 22 can be provided with a suitable microphone and speaker system. In addition, the two-way audio communication device 24 can be adapted to communicate with the audio server system 12 using either the network 20a or 20b. As discussed below, the computer terminal 22 can be provided with a web browser to permit the moderator to access a variety of information provided by the audio server system 12 regarding the network-based audio/visual conferences. Such information may include call-in telephone numbers, scheduling information or the like and can be provided on a web-page.

The network 20a may be a packetized or packet-switched network such as the world's public IP-based packet-switched networks, also known as the Internet or some other network-type, such as a wide area network (WAN) or local area network (LAN). The network 20b may be a circuit-switched network such as a public switched network typically used to make telephone calls, i.e., the network of the world's public circuit-switched telephone networks, also known as the PSTN. However, it should be understood that the networks 20a or 20b may be provided as other types of networks, such as a cellular telephone network. For purposes of clarity, the network 20a will be referred to hereinafter as a “packetized” or “packet-switched” network, and the network 20b will be referred to hereinafter as a “switched network.” In an exemplary embodiment, the two-way audio communication device 24 is a conventional telephone provided separately from the computer terminal 22 and communicates with the audio server system 12 via the switched network 20b.

The guest terminal 16 is also provided with a two-way audio communication device 30, which is shown by way of example as a telephone connected to the switched network 20b. However, it should be understood that the communication device 30 can be implemented in other manners, such as a computer terminal having suitable software and a microphone and speaker, or a landline telephone, mobile telephone, soft phone or voice over internet telephone. In addition, the guest terminal 16 may also be provided with a computer terminal (not shown) having access to the network 20a and also having a web browser to permit the guest to access a variety of information provided by the audio server system 12 regarding the network-based conferences. Such information may include call-in telephone numbers, scheduling information or the like and can be provided on a web-page.

The listener terminals 18 include a computer terminal 34 for accessing a variety of information provided by the audio server system 12, such as call-in telephone numbers, scheduling information, one-way audio streams of real-time or near real-time network-based audio/video conferences, or stored audio streams of past (not real-time) audio/video conferences. The listener terminals 18 may also include a separate one-way communication device 36 permitting the listener to listen to audio streams of real-time or near real-time network-based audio/video conferences. The one-way communication device 36 can be implemented, by way of example, as a two-way communication device, such as a landline telephone, mobile telephone, soft phone or voice over internet telephone, only allowing the listener to listen to the audio streams of real-time or near real-time or past network-based audio/video conferences.

The computer terminal 22 or 34 may be a computer having an Internet connection, for example through a direct Internet connection, a LAN, or through an Internet service provider. The computer terminals 22 or 34 may be a windows-based PC, a Macintosh, a cellular telephone or a personal data assistant for example. The computer terminals 22 or 34 can include speakers and web-browser software, such as Microsoft's “Internet Explorer” or Netscape's “Navigator,” having audio/video player software such as Real Network's “Real Player” or Windows™ Media Player for receiving media streams. The computer terminal 22 may also include a microphone and software for audio output/input to permit two-way audio communication with the audio server system 12.

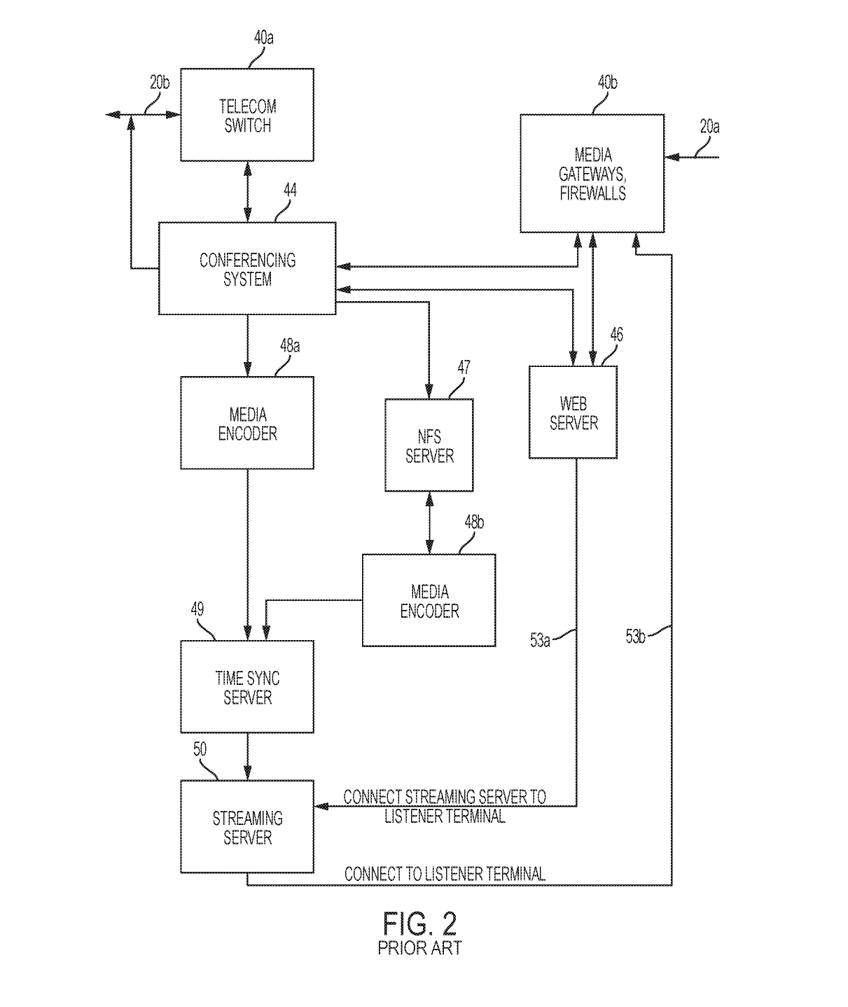

One embodiment of the audio server system 12 is shown in more detail in FIG. 2. The audio server system 12 is provided with one or more interface devices 40a and 40b for interfacing the audio server system 12 with the networks 20. In the example shown, the interface device 40a is shown as a telecom switch 40a for communicating with the switched network 20b, and the interface device 40b is shown as one or more media gateway, and firewall 40b for communicating with the packetized network 20a.

The audio server system 12 is also provided with a conferencing system 44, a web server 46, one or more content storage devices, e.g., database or NFS servers 47, one or more real-time media encoder 48a, one or more archive media encoder 48b, a time sync server 49, and a streaming server 50. The moderator terminal 14, and the guest terminal(s) 16 communicate with the conferencing system 44 via the networks 20a, 20b and interface devices 40a and 40b to provide a telephone conference connection for two-way audio communication during the network-based audio/video conference. The listener terminal(s) 18 communicate with the conferencing system 44, or the streaming server 50 to receive one-way or two-way communication during the network-based audio/video conference. When the listener terminal(s) 18 communicate with the conferencing system 44 in a two-way manner, i.e., unmuted, such listener terminal(s) 18 function similarly to guest terminal(s) 16.

The real-time media encoder 48a receives, in real-time or near real-time, the audio data (or a representation thereof) of the network-based audio/video conference and converts such audio data (or a representation thereof) into a streaming media format. Such audio data is then passed to a time sync server 49.

During the audio/video conference, the conferencing system 44 outputs a representation of the audio data to the content storage device, e.g., database or NFS server 47, to record the representation of the audio data and save such representation as a content file. Once the audio/video conference is over, the file is output to the archive media encoder 48b, which encodes the representation of the audio data into a streaming format. This encoded data is input to the time sync server 49, described previously. The time sync server 49 then provides the representation of the audio data to the streaming server 50. A hyperlink or button may then be provided on a web page provided by the web server 46 containing a URL directing a listener terminal 18 to the representation of the audio data in the streaming format hosted by the streaming server 50. It should be understood that the real-time media encoder 48a and the archive media encoder 48b can be implemented as a same media encoder, or separately.

The audio server system 12 also includes the web server 46. The web server 46 functions as an interface between the conferencing system 44 and the streaming server 50 of the audio server system 12 and the network 20a, and runs web server software (stored on one or more computer readable medium) to generate and deliver various web pages for display at the moderator, guest and listener terminals 14, 16 and 18. As discussed in detail below, such web pages delivered by the web server 46 include various input sections and graphical user interfaces (GUIs) that enable (1) remote moderator users to interactively schedule, setup, and control two-way communication access to the network-based audio/video conference, (2) remote guest users to interactively join, communicate with the moderator and listen to the network-based audio/video conference, and (3) remote listeners to listen to the network-based audio/video conference or become guests. The web server 46 enables remote listeners to listen to the real-time or near real-time network-based audio/video conference by connecting the listener terminals 18 to the streaming server 50. In one embodiment, the web server 46 can also connect the listener terminal 18 to the conferencing system 44. This feature is described in more detail below.

In an exemplary embodiment, the various web pages provided by the web server 46 are available to the public via the network 20a and the web server 46 connects listener terminals 18 to the streaming server 50 without typically requiring any authentication, invitation or verification (in certain instances authentication or verification may be required, such as when the show includes explicit material, and in certain instances the moderator can send out invitations to promote their show). So, the network-based audio/video conference is made available for essentially any listener having a listener terminal 18 capable of accessing the web server 46 and having streaming media software loaded on their listener terminal 18 for converting the representation of the audio data in the streaming media format into sound. As will be discussed in more detail below, due to the compatibility of the audio server system 12 with the packetized network 20a and the switched network 20b the moderator(s), guest(s) and listener(s) can setup, schedule, participate and/or listen to the network-based audio/video conference utilizing conventional telephones and computers having web browsers.

### 2. Overview of function of the Audio Conferencing System 10

During a network-based audio/video conference, audio is received by the conferencing system 44 from the two-way communication device 24, e.g., the telephone, of the moderator terminal 14 via the network 20b. The conferencing system 44 transmits a representation of the audio to guest terminal(s) 16 or listener terminal(s) 18 in a first listener group via the network 20b, and also transmits (or at least makes available) a representation of the audio to guest terminal(s) 16 or listener terminal(s) 18 in a second listener group via the packetized network 20a. The audio/video conference can be transmitted to the first listener group and the second listener group in real-time or near real-time (e.g., within a time delay of a few seconds).

A moderator can be a person who wishes to transmit voice, music, or any other suitable audio for one or more talk shows or audio/visual conferences and utilizes the moderator terminal 14 to communicate with the audio server system 12 via the network 20a or 20b. From the standpoint of the system 10, the moderator can be identified by a password (such as a PIN), but may be identified by any suitable method, such as CallerID or voice signature. A talk show or audio/visual conference can be scheduled for a particular day and time and may be scheduled for a particular timeslot (including start time and end time). However, in other embodiments, the talk show or audio/visual conference can be unscheduled or spontaneous. The talk show or audio/visual conference can be associated with a particular moderator (or moderators). A talk show or audio/visual conference can be described as scheduled, pre-show, in progress, or completed. The web server 46 can be adapted to permit the moderator to invite guests or listeners to the audio/video conference. In this regard, the moderator can login to a computer system hosted by the web server 46 and customize and send e-mail invites to friends and colleagues.

A “guest” is a listener who wishes to listen to the talk show or audio/visual conference and also engage in two-way communication with the moderator(s) during the talk show or audio/visual conference. From the standpoint of the system 10, the guest may be identified by a password (such as a PIN), or any other suitable method, such as CallerID or voice signature.

A “listener,” or “first listener,” or “second listener” is a person who wishes to listen to or view the talk show or audio/visual conference and receive the voice, music, or other suitable audio from the moderator and/or guest. From the standpoint of the system 10, a listener can be authenticated or verified, or not, by any particular method such as a password (such as a PIN), callerID or voice signature, although certainly the telephone number, IP address or other identifier of the listener terminal 18 may be automatically provided to the audio server system 12 for an identification of the listener terminal 18.

A first listener group is one or more listeners or guests in separate locations. A second listener group is one or more listeners or guests in separate locations from the listeners or guests in the first listener group.

An audio/visual conference can be either unidirectional or bi-directional, for example, participants might only be able to receive information but not input information or communicate back in the conference. Audio/visual conferences can contain only audio, only video, or both audio and video. All combinations of these embodiments are contemplated.

A “computer readable medium,” as used herein, refers to a device capable of storing data in a format that can be read by a computer. Examples of “computer readable mediums” include a memory, a magnetic disk, an optical disk or a tape.

### 3. Receiving and Transmitting Audio

A person seeking to be a “moderator” typically visits the web server 46 utilizing their moderator computer 22 and signs up for a show and agrees to a password. Then, the web server 46 provides the moderator with a moderator telephone number. After the moderator signs up for a show and agrees to a password, the moderator can call the moderator telephone number and identifies themselves with the password, as shown in FIG. 2 to connect to the conferencing system 44. If there is a show scheduled to start within a predetermined period (such as 15 minutes), an audio signal is transmitted to the moderator (as a pre-recorded voice) indicating the time until the start of the show. During the talk show or audio/visual conference, audio is typically passed from the moderator terminal 14 via the network 20b to the conferencing system 44. The audio may be transmitted through the circuit-switched telephone network 20b using any suitable audio codec. The telecom switch 40a can evaluate the caller ID of the moderator, and uses the G.729 audio codec for phone calls from an international (or remote) location and the PCMU audio codec for phone calls from a domestic (or nearby) location. However, other types of audio codecs could be used.

Then, a representation of the audio is transmitted to the guest terminal 16 or listener terminal 18 of one or more listeners or guests in a first listener group via the telecom switch 40a and network 20b to deliver a representation of the voice, music, or any other suitable audio from the moderator to one or more guests and listeners. The representation of the audio may be an exact representation of the voice, music, or any other suitable audio transmitted from the moderator. The representation of the audio, however, is can be a compressed, filtered, censored, or otherwise processed version of the voice, music, or any other suitable audio transmitted from the moderator. The audio may be transmitted through the circuit-switched telephone network 20b using any suitable audio codec. The audio method and system can evaluate the caller ID of the moderator, and can use the G.729 audio codec for phone calls from an international (or remote) location and the PCMU audio codec for phone calls from a domestic (or nearby) location. However, other types of codecs could be used.

The audio server system 10 can provide the first listener group with a listener telephone number that corresponds to a particular moderator or show. The listener telephone number is typically provided to the guests or listeners in the first listener group by posting the listener telephone number on a web page associated with the particular moderator or show provided by the web server 46. However, the listener telephone number can be provided in other manners, such as by including the listener telephone number in advertisements for the talk show or audio/visual conference.

When a first listener calls the listener telephone number, the conferencing system 44 may be configured to play an audio clip (such as a “greeting”) associated with the particular moderator or show. If there is a show scheduled to start within a predetermined period (such as 15 minutes), the conferencing system 44 can transmit an audio signal to the first listener (as a pre-recorded voice) indicating the time until the start of the show. Although the audio/video conference system 10 might not require a password from the first listener, the system 10 may require a password from the first listener in certain situations (e.g., shows with explicit material).

The audio server system 12 can also transmit or pass a representation of the audio to a second listener group in real-time or near real-time via the network 20a. The representation of the audio is automatically provided to the media encoder 48a and the database, e.g., NFS server 47, from the conferencing system 44. The NFS server 47 records the representation of the audio (in real-time or near real-time) and saves the representation as a file. The real-time streaming of the representation of the audio can be accomplished by setting the media encoder 48a up as a “listener” of the audio/video conference. In one embodiment, this is accomplished by placing an inbound or outbound phone call to the media encoder 48a by the conferencing system 44 to connect the media encoder 48a as a “listener” of the audio/video conference. The connection between the conferencing system 44 and the media encoder 48a can utilize a high quality codec.

As discussed above, the audio stream can be provided to the listener or the guest utilizing either the network 20a or 20b. To listen to the audio stream utilizing the network 20a, the listener or guest utilizes their guest terminal 16 or listener terminal 18 to browse a web page associated with the moderator, talk show or audio/visual conference. The web page can be provided with suitable hyperlink(s) adapted to provide a listener URL, that corresponds to a particular moderator or show, to the listener terminal 18 upon activation by the listener. When the listener points their web browser to the particular URL, the audio server system 12 connects the listener terminal 18 to the streaming server 50 to connect the listener to the audio stream. This can be implemented by the web server 46 sending a signal via a signal path 53a to the streaming server 50 to activate the streaming server 50 to connect to the listener terminal 18 via a signal path 53b, or by the web server 46 providing the listener URL to the listener terminal 18 and then the listener terminal 18 connecting to the streaming server 50 via the signal path 53b. The signal paths 53a and 53b are shown separately for purposes of illustration, however, the signal paths 53a and 53b could be the same or different.

To connect to the audio/video conference via the network 20b, the moderator, guest or listener uses their terminal 14, 16 or 18 to dial into the audio/video conference utilizing a “call-in” number. Or, the moderator, guest or listener can utilize their terminal 14, 16 or 18 to view a web page from the web server 46 and actuate a hyperlink that actuates an outbound call to connect to the conferencing system 44 using Voice Over IP via the networks 20a and the media gateways, firewall 40b.

The streaming server 50 may be configured to play an audio and/or video clip (such as a “greeting”) associated with the particular moderator or show. If there is a show scheduled to start within a predetermined period (such as 15 minutes), the system 10 can include a step of transmitting an audio and/or video signal to the listener indicating the time until the start of the show. Although the system 10 might not require a password from the second listener, the system 10 may require a password from the second listener in certain situations (e.g., shows with explicit material).

### 3. Example Implementation

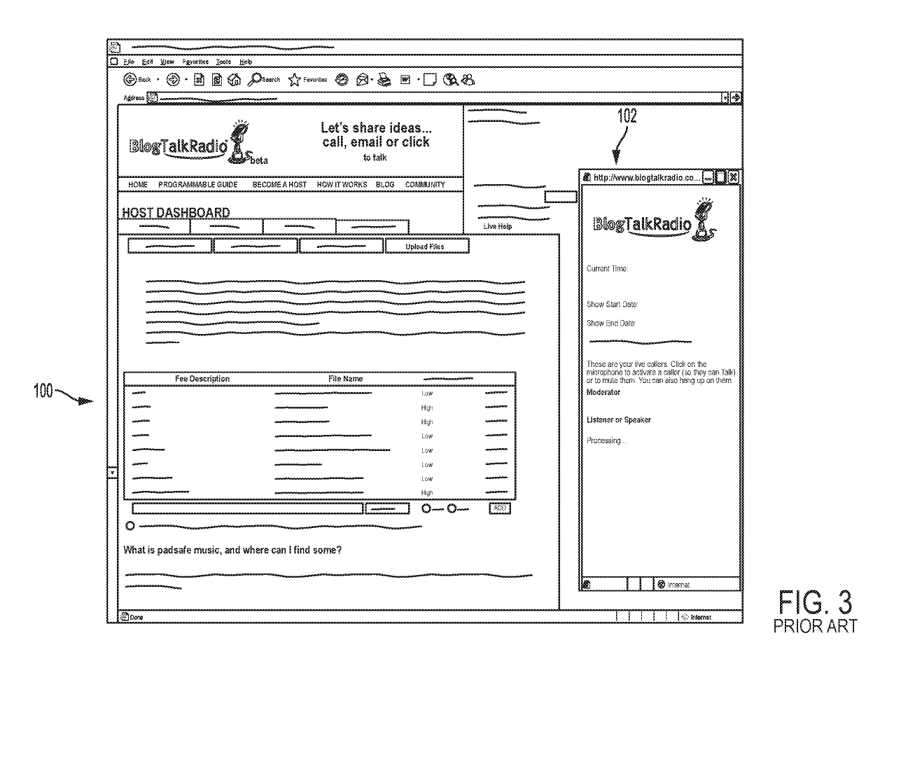

FIGS. 3-9 are exemplary web pages generated by a web server of the audio server system in accordance with embodiments. In particular, FIGS. 3-9 illustrate exemplary web pages enabling the moderator to control the network-based audio/video conference in accordance with example embodiments.

Shown in FIG. 3 is an exemplary “upload files” web page 100 generated by the web server 46 of the audio server system 12 in accordance with an embodiment. The “upload files” web page 100 has an upload file area to permit the moderator to upload sound files, such as short sounds or pre-recorded shows, to the audio server system 12 for playing during the audio/video conference. The sound files can be in any suitable format, such as .wav, .wma or .mp3 format. When the moderator is hosting the audio/video conference, the upload files page can include a “play button” or other suitable hyperlink permitting the moderator to play the sound files during the audio/video conference. Exemplary web page 100 can also be used to upload content files for later insertion of an advertisement or other foreign content.

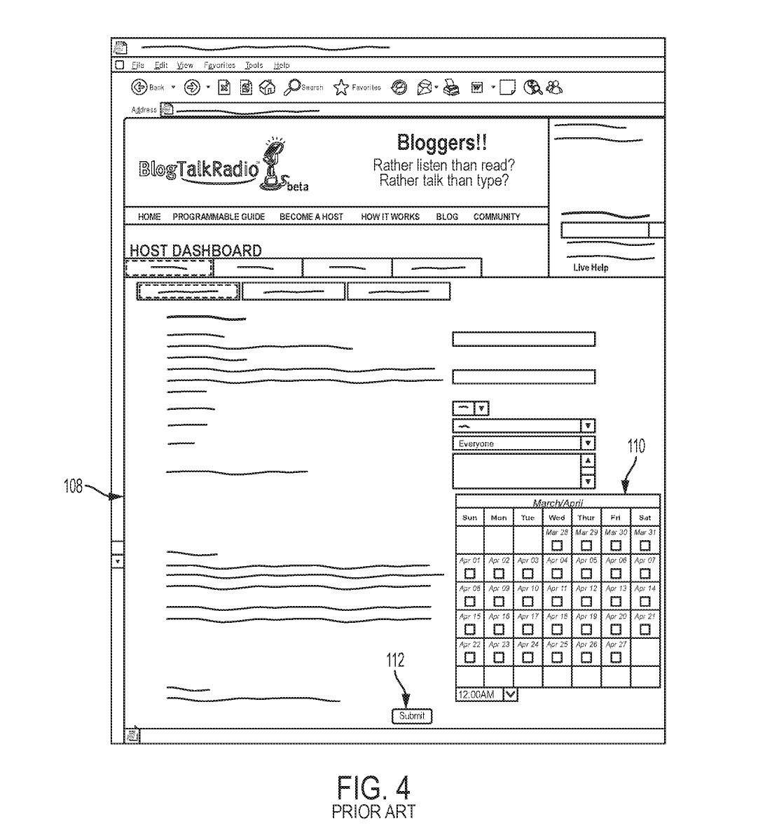

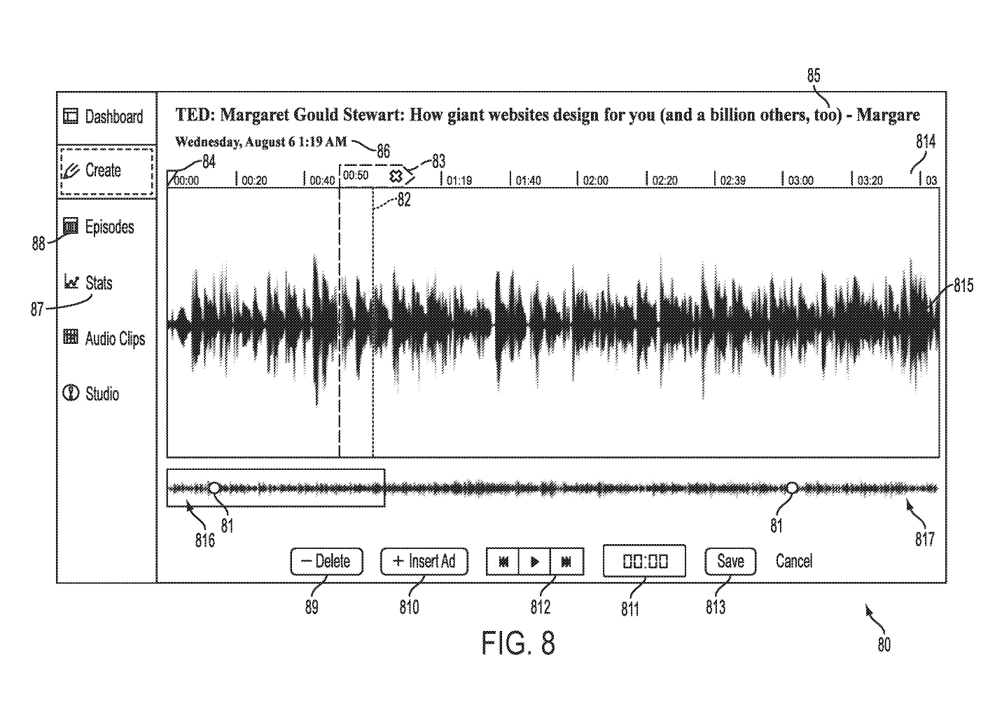

Referring to FIG. 4, shown therein is an exemplary “Segments” web page 108 generated by the web server 46 of the audio server system 12. The “segments” web page 108 includes a variety of fields permitting the moderator to schedule various information with respect to a proposed talk show or audio/visual conference, such as segment title, segment length, genre, rating, or segment tags. In addition, the “segments” web page 108 includes a scheduling area 110 permitting the moderator to select the date and time of the proposed talk show or audio/visual conference, as well as a select button 112 enabling the moderator to submit the schedule of the proposed talk show or audio/visual conference. Segments can be identified using the tools illustrated by FIGS. 8-10.

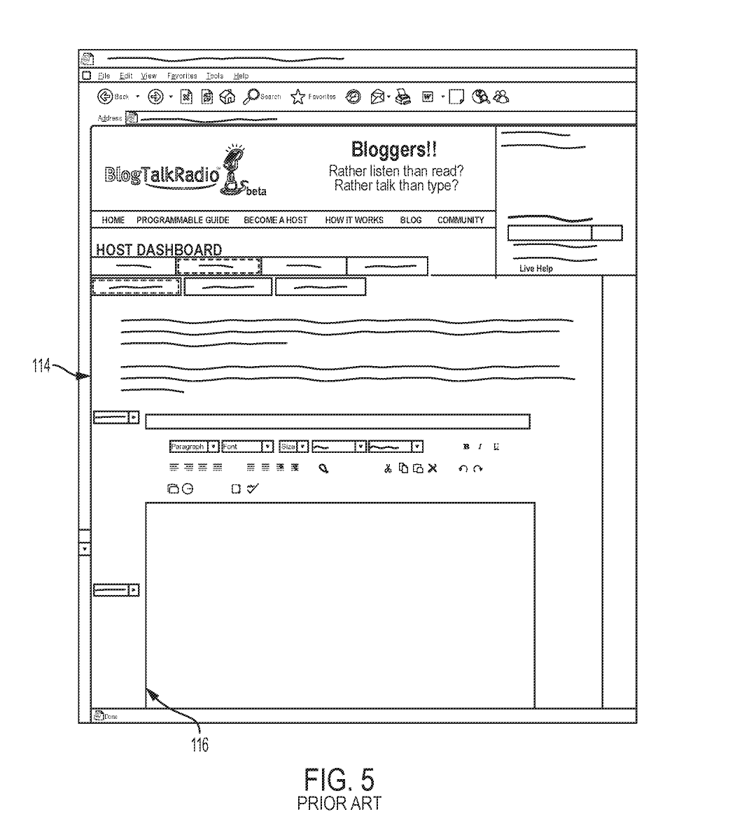

Referring to FIG. 5, shown therein is an exemplary “segment/archives” web page 120 generated by the web server 46 of the audio server system 12. The segment archives web page provides a list of prior shows, organized by moderator, which have been recorded or uploaded, and are available to listen to.

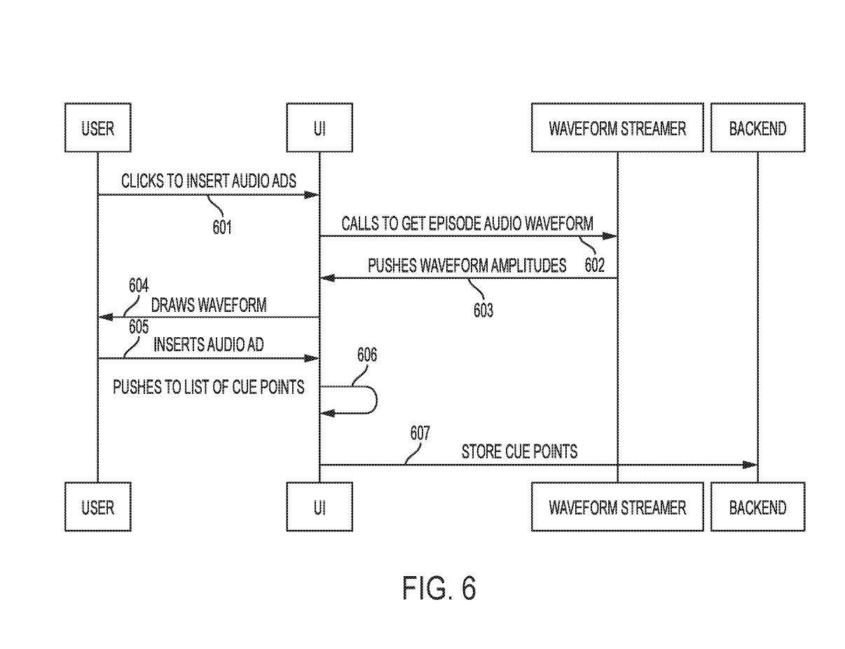

FIG. 6 discloses structure for customizing insertion markers in a content file. The structure includes a system of one or more special purpose computers configured to perform several steps. Step 1 can include determining user access rights via a lookup in a database. If the user has access, the user can request a content editor page, such as those illustrated in FIGS. 8-10, via, for example, an HTTP GET command to a web server. In step 2, the webpage can include an application, such as an ASP.NET application, that performs a SignalR call (via, for example, websockets, long polling or forever frame) to request a content file (e.g., an audio file) that can be displayed to a user on a time graph (e.g., audio waveform). In step 3, the server starts reading the content file from a database by, for example, downloading waveforms that digitally represent the content file, such as a content distribution network (CDN, such as those made by Akamai and Limelight) and pushes the waveform information while reading the content file. In step 4, the user computer can receive the waveform information via a visual representation on the user interface on an editor page. In step 5, the user can click on different parts of the waveform to place insertion markers (a mark that specifies where an ad or additional content can be inserted), depending on the user type, some restrictions may apply. For example users can be limited to the number of advertisements available, or there may be a minimum number of advertisements available, user can also be limited to the types of advertisements available, for example gender- or age-based. Some users may want to overly fill their content with ads, which can cause users to dislike listening to the content. Other users may not put enough ads in for the content provider to recoup their costs. An exemplary embodiment requires or allows one ad per 10-minute period. In step 6, as soon as the user clicks to place an insertion point, the web page can store internally that insertion point on an array that can be stored in the database. In step 7, when the user clicks on “Save,” the UI can push the insertion-point array using an Ajax call to the API that will put it on the database on the backend.

While the embodiment described above allows users to choose insertion points, other embodiments include automatically identifying insertion points. These insertion points can be identified by, for example, identifying periods of silence, time of day, time of playback, beginning or end, etc.

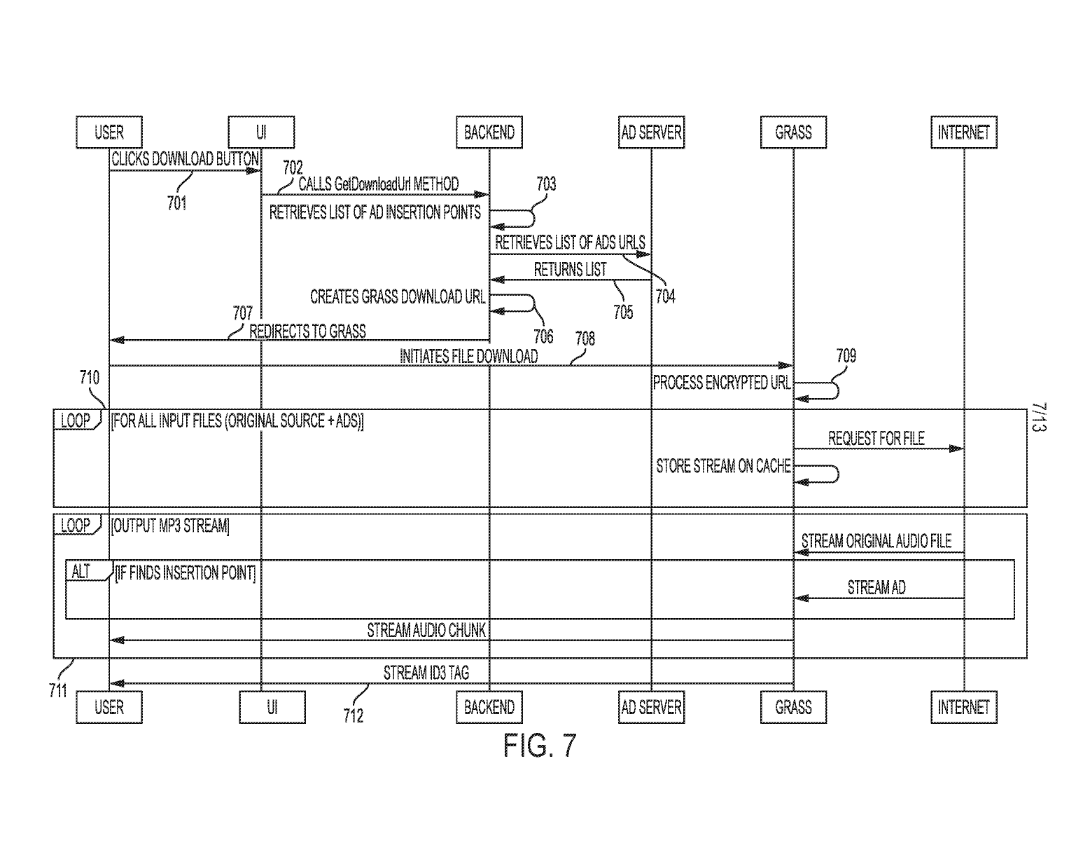

FIG. 7 illustrates exemplary structure for downloading a content file and automatically choosing and inserting advertisements or other foreign content into the content file. In step 1, the user selects an archived episode that was previously marked for ad insertion and chooses to download an archived episode. In step 2, the user may make a call to the backend via the method GetDownloadUrl on the EpisodeService class that will generate a URL pointing to the content file. In step 3, the backend retrieves the insertion points. In step 4, the backend calls the ad server (e.g., abacast server) to get a list of the ad URLs required to fulfill the cue points or insertion points. In step 5, the abacast server returns the list of ad URLs. In step 6, the backend server generates a URL targeting the Groovy Real-time Audio Splicing Service (“GRASS”) server to send to the user, and a HASH based on the input parameters (source file, ads files, insertion points, etc.) that uniquely represents the content file containing the archived episode and links to ads that can be targeted at the user making the request. In step 7, the backend server transmits the URL generated in step 6 to the user. In some embodiments the URL can be encrypted to increase security. In step 8, the user clicks the URL, which causes the user's browser to perform an HTTP GET operation to the GRASS server. When the GRASS server receives the HTTP GET command, it decrypts the hash or simply decodes it into the parameters to perform the ad insertion. In step 10, the GRASS server prepares to stream the content file including the ads, and caches the output for further reuse. Alternatively, if the content file with the ads already was pre-constructed, then the GRASS server can stream that version and not reconstruct the same file, which can decrease latency. The system may determine which ads to choose based on several parameters, such as location, the user's device type or user agent, cost per impression (CPM), IP address, cookies on a user's computer, other user demographics, etc., which can be determined automatically via IP address lookups, or from other data inputted by the user. Using such information, embodiments can automatically target ads to particular users, thereby enabling advertisers to reach their intended audiences better, even when these audiences are listening to the same piece of content. Caching for later use results in improved performance and efficiency for subsequent request for the same content file, provided that the same ads or foreign content are still desired. In step 11, the GRASS server starts streaming the content file, and when it reaches an insertion point it will stream the ad file and then resume streaming the original file; this happens until the content file is fully streamed. In step 12, the GRASS server transmits the ID3 tags to the user. Ads may be streamed either from the Internet directly or downloaded to the GRASS server for streaming to the user.

After the content file is constructed, as illustrated in step 6, embodiments can store the reconstructed content file on a CDN or other local or remote storage such that the content file need not be reconstructed. The reconstructed file can have an end time, e.g., the time that the content file should no longer be used, such as the soonest expiration date of one or more of the ads in the content file. The end time can also be a default time period, such as one week. After the end time, the content file can be deleted and reconstructed once again with new advertisements.

Advertisements can come directly from advertisers or be read by the content creators themselves, which is sometimes called “native” advertisements. Advertisements for video can be either full-screen or partial screen, the ads can either be audio, video or static images. The ads typically comprise multiple files to be inserted at the insertion markers. Ads can be chosen in real-time when needed while streaming content. Some embodiments stream content via traditional streaming methods, such as using a media streaming widget, e.g., windows media player or QuickTime™. Other embodiments can utilize a custom player that can either pause content playback while delivering an advertisement, or alternatively playback can continue with the advertisement placed directly into the content being played back via a content stream or via a locally-stored file.

Additional embodiments include the feature of automatically recording an ad being delivered to a user, either via a log that the ad was downloaded or via a local log that the user actually viewed or listened to the ad, or whether the ad was displayed or played to the user. Such an event can decrement a counter of the total number of ads sold in a campaign. In addition, counters for the content creator can be incremented to record a number of ads delivered as the result of delivering the content creator's content. The incremented counter can then be used to determine payments due to the content creator as a result of advertisement delivery.

Embodiments can determine which ads to serve based on ad campaigns sold by the content distributor, or ads sold by third parties selling ad inventory owned by the content distributor. The ads can be stored on the Internet or delivered to the content distributors by the advertisers. It can be advantageous for advertisers to maintain their advertisements on the Internet to ensure that their advertisements are up-to-date, thereby allowing them to revise their advertisements without establishing a new contract or contacting the content distributor directly. In this way, ads can be continuously updated automatically.

FIGS. 8-10 illustrate embodiments of content marking tools used to edit a content file to, for example, place insertion markers for inserting advertisements or other foreign content. Other forms of content marking tools can be used to place insertion markers at certain times during playback of a content file, whether it is an audio or video file. These figures share many features, but also have some differences. First, FIG. 8 illustrates a window 80 that includes the display of a portion 815 of a content file, which in this example is a waveform representation of an audio file, which is also illustrated as a full waveform 817. The title of the content file appears at 85, which was created on the date 86 appearing below title 85. Portion 815 can be seen in window 816. Users can switch between episodes by pressing button 88, or view stats regarding the content file 817 by pressing button 87. Window 816 can be moved to the left or right to expose different parts of audio file as represented by the waveform 815. The playback marker 84 indicates the location of the file that when play button 812 is hit, where the audio will play from. The playhead 84 also determines the initial location of the ad insertion point when the insert ad button 810 is clicked. The user, e.g., the content creator, can insert ad insertion points using the insert ad button 810, with the ad insertion point marked by vertical dotted line 83 with a flag with a “X” button within it for deletion. The user can also delete an ad insertion point by pressing delete button 89. Embodiments can automatically suggest locations of insertion markers that the user can move. The user can click the flag 83 indicating the ad insertion point and move the ad insertion point, as indicated by the flagged vertical dotted line 83 to the left and to the right to locate the desired location for ad insertion. Ad insertion point 83 is also illustrated in the full waveform 817 as the first, leftmost dot 81. A second, rightmost dot 81 appears further near the end of waveform 817 to indicate location of another ad insertion point. Users can also delete ad insertion points by pressing “X” on the flag of the insertion point 83. Vertical line 82 further illustrates a cursor for a currently selected location on waveform 815, and a user can move the playback marker 84 to that location or can place another ad insertion point there. Time indicator 811, which displays the location of on the timeline 814 of playback marker 84, illustrates the time remaining in the content file for playback. The user can move playback marker 84 to the left or right, which correspondingly changes the display of the time in time indicator 811. Alternatively, the user can use playback buttons 812, which includes play, fast forward, and rewind. In this example of an audio file, the user can push the play button and hear playback to aid in reviewing a desired location of an insertion marker. When the user is done placing insertion markers, the user can press the save button 813.

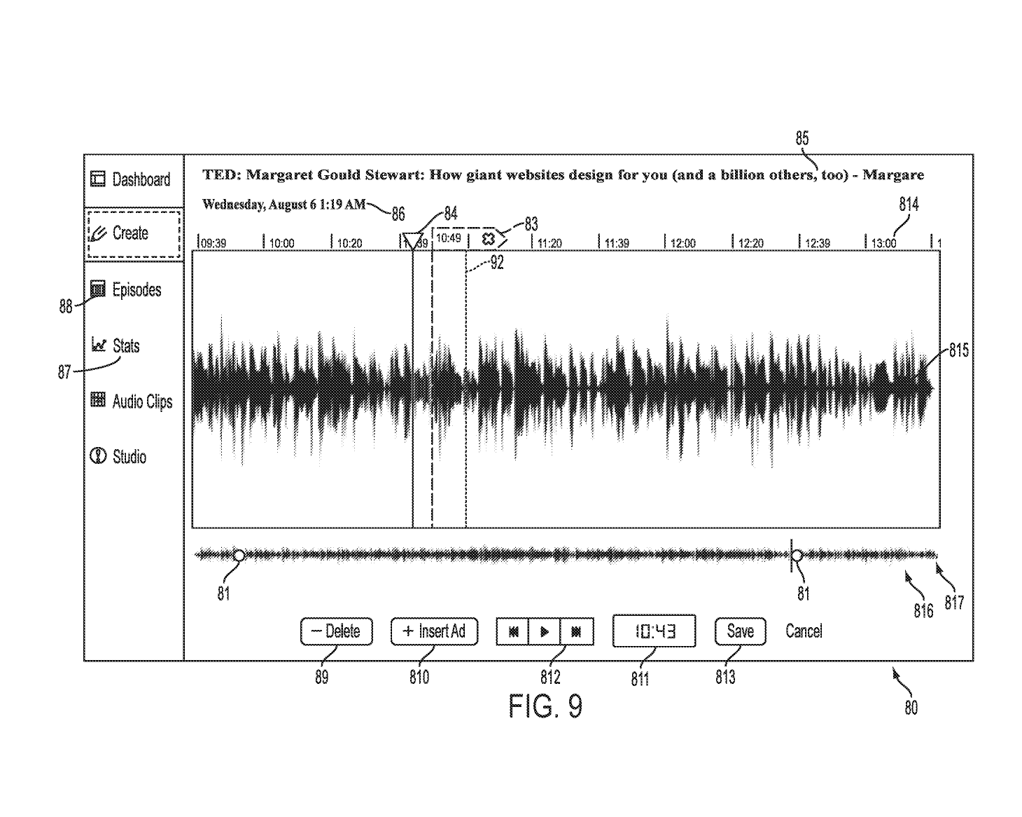

FIG. 9 is very similar to FIG. 8, except that window 816 is moved all the way to the right, such that the second insertion marker 81 is visible in content file 817. In addition, playback marker 84 is moved later into the content file. Vertical line 92 further illustrates a cursor for a currently selected location on waveform 815, and a user can move the playback marker 84 to that location or can place another ad insertion point there.

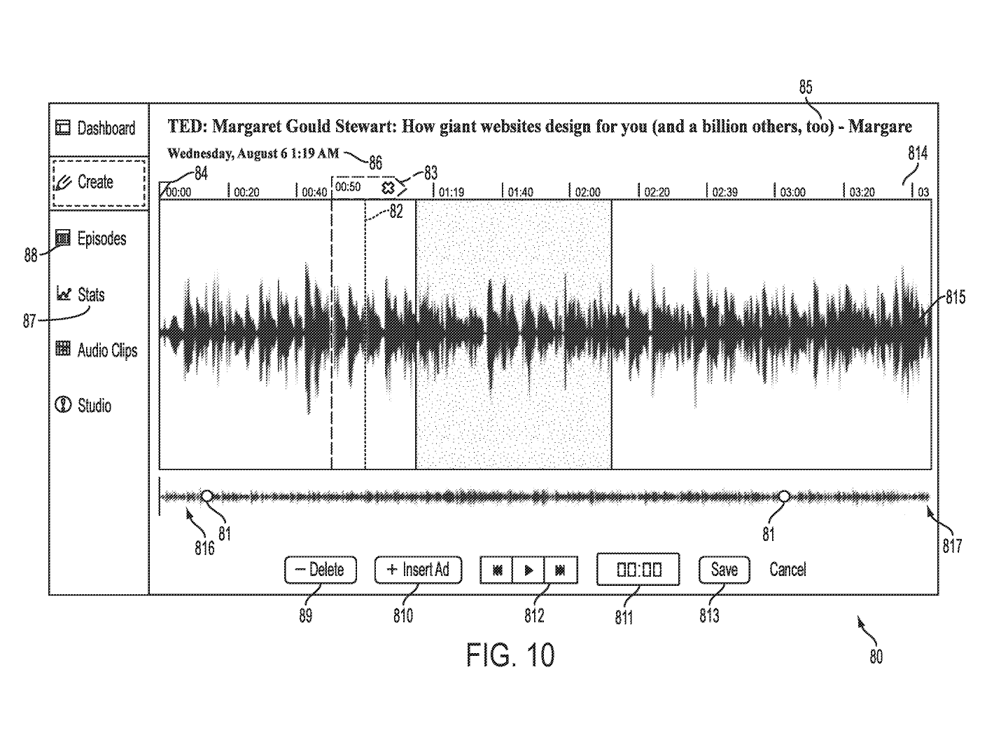

FIG. 10 is also similar to FIG. 8, except that FIG. 10 illustrates a shaded area on waveform 816. The shaded area can be used for selecting portions of a content file to remove by deleting, splicing, or cutting. This can be used in conjunction with placing an insertion marker, as some embodiments can automatically place an insertion marker in place of the removed portion of the content file. This makes for a smoother transition between the two portions of the content file that remain after removing the content between them.

In some embodiments, sections of a content file might not actually be deleted, but instead may be skipped between deletion markers. For instance, when a player reaches a deletion marker, playback will skip until the next deletion marker. In streaming embodiments, packets between the deletion markers will not be streamed. In downloading embodiments, a content file is reconstructed with inserted content, based on insertion markers, and deleted sections are removed based on deletion markers.

In other embodiments, users can move insertion markers, even after the files have been delivered to recipients. In another embodiment, users can receive content files with unique placement of ad insertion markers. For instance, some recipients may pay a premium for fewer advertisements or no advertisements. This can be accomplished by storing several versions of insertion markers for a content file, or insertion markers can be skipped, depending on whether a recipient should receive more or fewer advertisements.

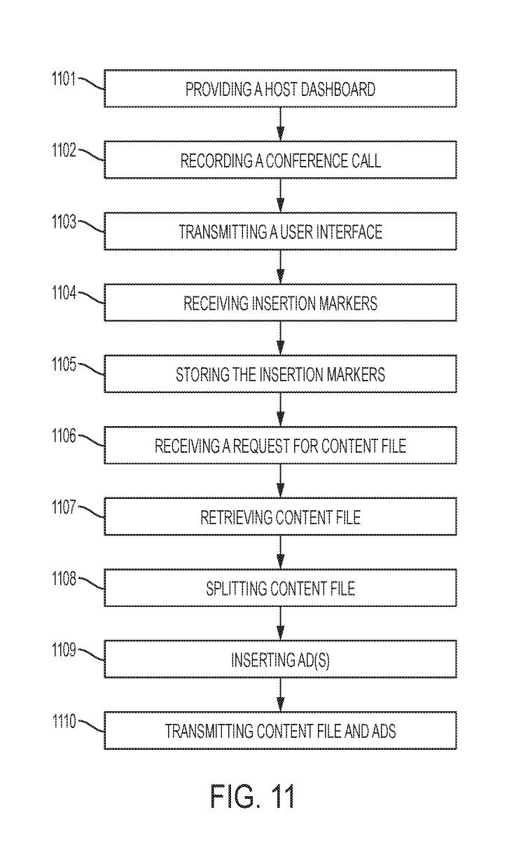

FIG. 11 illustrates a flow chart of one embodiment. Note, however, that embodiments do not require any ordering of the steps. Indeed, one of the advantages of some embodiments is to begin streaming a file while determining which ads to insert, and inserting the ads. This can occur in parallel with the beginning of streaming of the content file. In step 1101, the audio server system can provide a host dashboard, which can enable a moderator to invite one or more guests to participate in the conference call based on information provided by the audio server system, the audio server system enables the moderator to engage in bi-directional communication with one or more guests. In step 1102, the audio server system can record the conference call to generate a content file; the audio server system can also store the content file in a database for later retrieval. In step 1103, a database can transmit a user interface to a user to display an image representative of the content file. The user can select locations in the content file to place insertion markers, such as the way illustrated in FIGS. 8-10. Next, in step 1104, the audio server system can receive the insertion markers, which can be stored in the database in step 1105. In step 1106, a user can transmit a request to download the content file, which the audio server system receives. In response to the request, in step 1107, the audio server system can retrieve, from the database, the content file and the insertion markers. In step 1108, the audio server system can split the content file into parts at locations indicated by the insertion markers. In step 1109, the audio server system can insert advertisements or foreign content between the parts of the content file. In step 1110, the audio server system can transmit the content file and advertisements or foreign content to the listener.

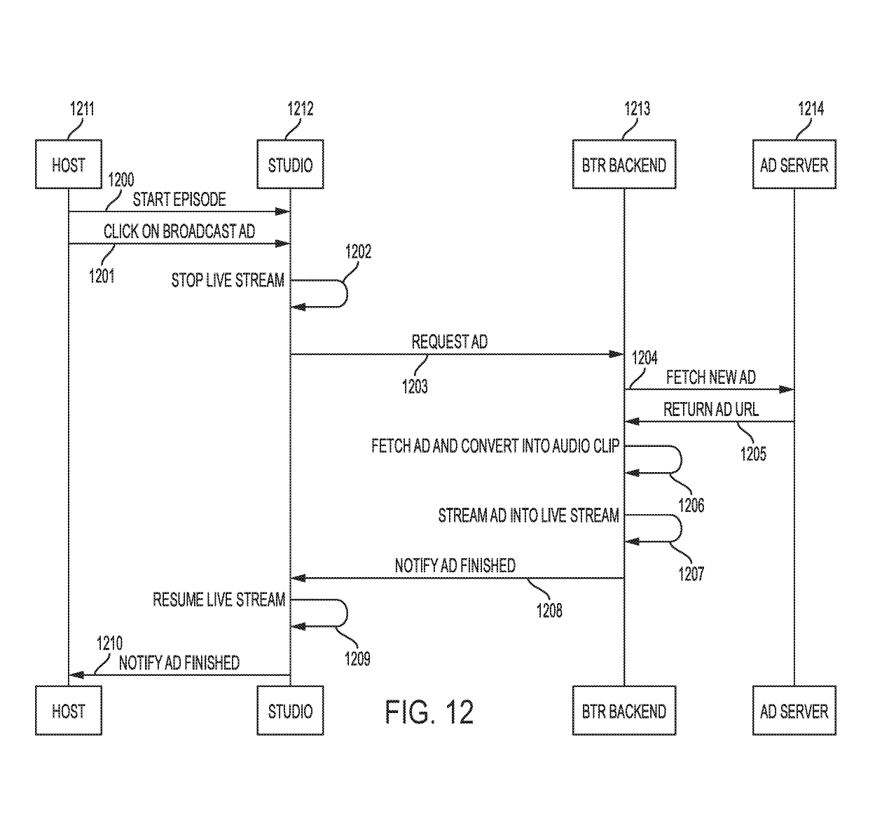

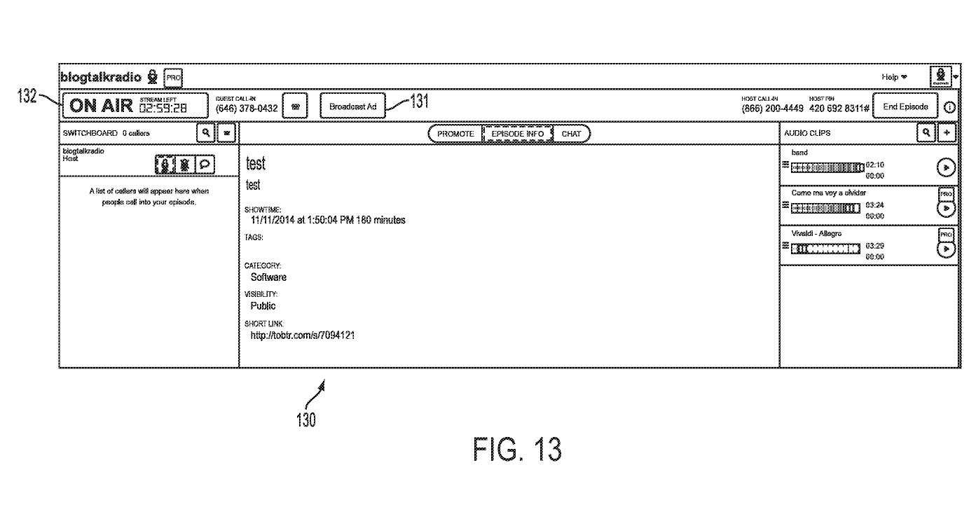

FIGS. 12 and 13 illustrate examples of a live recording embodiment. Specifically, FIG. 12 illustrates a software algorithm for inserting advertisements or other foreign content into a live audio stream (other types of content, such as video, would work similarly). Step 120 illustrates initiating a live audio stream, similar to a live radio show, in which host 1211 contacts studio 1212 to initiate a stream that listeners can receive. The host 1211 can contact the studio 1212 via a host dashboard, such as that illustrated in FIG. 13. After initiation, in step 121, the host 1211 can press an ad insertion button (such as button 131 in FIG. 13) which creates a call to the studio 1212, which can then stop the live stream in step 122. Studio 1212 can then request an ad from the Backend 1213, in step 123, and backend 1213 can request an ad or foreign content from ad server 1214 (e.g., any audio ad server or CDN set up to accept and respond to such requests) to fetch an ad or foreign content in step 124. At the same time, this software can work in conjunction with steps 5-7 of FIG. 6 to store cue points when recording the live stream. Cue points, or insertion points, can be stored with the live stream while the live stream is recorded, such that future listeners of the recorded live stream can receive custom ads or foreign content, and not necessarily the ad or foreign content originally streamed during the live stream. The ad server can return a URL to the ad or foreign content in step 125. Step 126 illustrates using the URL to fetch the ad or foreign content from the Internet and converting it into an appropriate format for the stream, which in this case is an audio stream. This can be important when, for example, the ad or foreign content was originally in a different format, such as a video format or different audio format, which then needs to be converted into an audio format. Some embodiments do not require this conversion if the ad or foreign content is already in the proper format. In step 127, the ad or foreign content is inserted into the audio stream for listeners to receive. Step 128 illustrates sending a notification to studio 1212 that playback of the ad or foreign content is completed, such that live streaming can resume in step 129. In step 1210, live streaming can resume and the software can indicate resumption to the host 1211 by, for example, the “ON AIR” indicator 132 illustrated in FIG. 13.

FIG. 13 illustrates an exemplary host dashboard that incorporates features of such studios that were discussed above. However, this host dashboard features an ad insertion button 131, labeled “Broadcast Ad.” The host 1211 can press the button any time an advertisement is desired or on prompt by the user interface as part of a messaging function triggered by the backend system to communicate to the host. Then, the process of retrieving and playing the ad or foreign content can commence, as illustrated in FIG. 12, and “ON AIR” indicator 132 can turn off during playback of the ad or foreign content, and “ON AIR” indicator 132 can turn back on as described above in step 1210, above.

As a person skilled in the art will recognize from the previous detailed description and from the figures and claims, modifications and changes can be made to the exemplary embodiments of the invention without departing from the spirit and scope of this invention defined in the following claims.

We claim:

1. A method comprising:
receiving, at a audio server system, a content file;
placing, via a content marking tool, insertion markers;
storing, via a content storage device, the content file and the insertion markers;
receiving, at the audio server system a request for the content file; and
delivering, via the audio server system, the content file to one or more listener computers, wherein delivering the content file comprises delivering advertisements during playback of the content file when playback reaches an insertion marker.

2. The method of claim 1, wherein receiving the content file comprises receiving a live stream.

3. The method of claim 1, wherein receiving the content file comprises receiving a previously recorded live stream.

4. The method of claim 1 further comprising identifying demographics of users of the one or more listener computers.

5. The method of claim 4 further comprising delivering advertisements based on the demographics of the users of the one or more listener computers.

6. The method of claim 1 further comprising automatically identifying locations for placing insertion markers.

7. The method of claim 6 further comprising providing an interface for moving or deleting the automatically placed insertion markers.

8. The method of claim 6 further comprising identifying moments of silence for automatically placing the insertion markers.

9. A method comprising:
providing, by an audio server system, a host dashboard, the host dashboard configured to enable a moderator to invite one or more guests to participate in a conference call based on information provided by the audio server system, the audio server system enabling the moderator to engage in bi-directional communication with the invited one or more guests;
recording, by the audio server system, the conference call to generate a content file;
storing, by the audio server system, the content file in a database at the audio server system;
transmitting, to a user, a user interface to display an image representative of the content file;
receiving, at the audio server system via a network, one or more insertion markers;
storing, in the database at the audio server system, the one or more insertion markers;
receiving, at the audio server system, a request, from one or more listener computers, to download the content file;
retrieving, from the database at the audio server system, the content file and the one or more insertion markers;
splitting, via the audio server system, the content file into parts at locations indicated by the one or more insertion markers;
inserting, via the audio server system, advertisements or foreign content between the parts of the content file;
transmitting, via the audio server system, the content file and advertisements or foreign content to the one or more listener computers.

10. The method of claim 9 further comprising providing an interface for placing one or more deletion markers, where the audio server system will not stream content that exists between the one or more deletion markers.

11. The method of claim 9 further comprising receiving a previously recorded content file.

12. The method of claim 9 further comprising identifying demographics of users of the one or more listener computers.

13. The method of claim 12 further comprising delivering advertisements based on the demographics of the users of the one or more listener computers.

14. The method of claim 9 further comprising automatically identifying locations for placing insertion markers.

15. The method of claim 14 further comprising providing an interface for moving or deleting the automatically placed insertion markers.

16. The method of claim 14 further comprising identifying moments of silence for automatically placing the insertion markers.

17. A system comprising:
an audio server system configured to provide a host dashboard and further configured to provide an audio stream;
a database configured to store the audio stream in a content file for future playback;
an ad server, in communication with the audio server system, configured to store advertisements or foreign content;
the host dashboard including an insertion point button configured to identify an insertion marker in the content file, wherein the audio server system stores the insertion marker in the database, and the insertion marker represents a location for one or more advertisements; and
a web server in communication with the database for streaming the content file to one or more users.

18. The system of claim 17, wherein the audio server system is further configured to automatically identify locations for placing insertion markers.

19. The system of claim 17, further comprising an interface configured to move or delete the automatically placed insertion markers.

20. The system of claim 17, wherein the audio server system is further configured to identify moments of silence to automatically place the insertion markers.
